(19) United States
(12) Patent Application Publication
(10) Pub. No.: US 2022/0317686 A1
(43) Pub. Date: Oct. 6, 2022

(54) REMOTE ASSISTANCE SYSTEM AND REMOTE ASSISTANCE METHOD

(71) Applicant: Woven Planet Holdings, Inc., Tokyo (JP)

(72) Inventor: Toshinobu WATANABE, Tokyo-to (JP)

(73) Assignee: Woven Planet Holdings, Inc., Tokyo (JP)

(21) Appl. No.: 17/713,283

(22) Filed: Apr. 5, 2022

(30) Foreign Application Priority Data
Apr. 6, 2021 (JP) 2021-064864

(51) Int. Cl. G05D 1/00; G06F 3/04817; H04R 1/40; H04R 3/00; H04S 7/00; G06F 3/16

(52) U.S. Cl. CPC G05D 1/0044; G06F 3/04817; H04R 1/406; H04R 3/005; H04S 7/30; G06F 3/165; H04R 2499/13; H04S 2400/11; H04S 2400/15

(57) ABSTRACT

A remote assistance system comprises a remote facility configured to assist an operation of a vehicle. A processor of the vehicle executes data processing of surrounding environment data of the vehicle, and transmission processing to transmit data for communication indicating the processed data by the data processing to the remote facility. The surrounding environment data includes sound data of the surrounding environment of the vehicle. In the data processing of the surrounding environment data, a type of a sound source included in sound data is estimated by an acoustic analysis of the said sound data. Subsequently, identification data corresponding to the estimated type is specified by referring to a database of the vehicle using the estimated type, and this is added to the data for communication.

The present application claims priority under 35 U.S.C. § 119 to Japanese Patent Application No. 2021-064864, filed Apr. 6, 2021, the contents of which application are incorporated herein by reference in their entirety.

### TECHNICAL FIELD

The present disclosure relates to a system and a method to remotely assist an operation of a vehicle.

### BACKGROUND

JP2018-77649A disclose a system to perform a remote operation of a vehicle. The system in the prior art includes a management facility on which an operator performing the remote operation resides. The remote operation by the operator is initiated in response to a request from the vehicle. During the remote operation, the vehicle transmits various data to the management facility. The examples of the various data include surrounding environment data of the vehicle acquired by an equipment mounted on the vehicle such as a camera. The examples of the surrounding environment data include image data and sound data. The surrounding environment data is provided to the operator via a display of the management facility.

When the surrounding environment data acquired by the in-vehicle equipment is directly transmitted to the management facility, data traffic increases. Therefore, in this case, there is a concern that communication delays and costs increase. In this respect, if the surrounding environment data is compressed prior to the transmission, the data traffic can be reduced to some extent. However, in the remote assistance of the operation of the vehicle including a remote operation, visual verification of the surrounding environment by the operator is of particular importance. Therefore, to allocate communication resources to image data communication, it is necessary to improve to reduce the data traffic of the sound data significantly.

One object of the present disclosure is to provide a technique capable of reducing the data traffic of the sound data transmitted from the vehicle to the management facility in the remote assistance of the operation of the vehicle.

### SUMMARY

A first aspect is a system for a remote assistance of an operation of a vehicle and has the following features.

The system comprises a vehicle and a remote facility configured to assist the operation of the vehicle.

The vehicle includes a memory, a processor, and a database.

In the memory of the vehicle, surrounding environment data of the vehicle is stored.

The processor of the vehicle executes data processing of the surrounding environment data, and transmission processing to transmit data for communication indicating the processed data by the data processing to a remote facility.

In the database of the vehicle, identification data corresponding to types of the environmental sound is stored.

The remote facility includes a memory, a processor, and a database.

In the memory of the remote facility, the data for communication is stored.

The processor of the remote facility executes data processing of data for communication, and control processing to play on a reproduction device of the remote facility data for reproduction indicating the processed data by the data processing.

The database of the remote facility alternative data of the environmental sound is stored.

The surrounding environment data includes sound data of the surrounding environment of the vehicle.

In the data processing of the surrounding environment data, the processor of the vehicle is configured to:

based on an acoustic analysis of the sound data, estimate a type of the sound source included in the said sound data; and

by referring to the database of the vehicle using the estimated type, specify identification data corresponding to the said estimated type and add it to the data for communication.

The processor of the remote facility is configured to:

in the data processing of the data for communication, by referring to the database of the remote facility using the specified identification data, identify alternative data corresponding to the estimated type; and

in the control processing, output the data for reproduction including the identified alternative data to the reproduction device.

A second aspect further has the following features in the first aspect.

The alternative data includes sound source icon data corresponding to the estimated type.

The reproduction device includes a display configured to output the sound source icon data.

In the data processing of the data for communication, the processor of the remote facility is further configured to select the sound source icon data corresponding to the estimated type by referring to the database of the remote facility using the specified identification data.

A third aspect further has the following features in the second aspect.

The alternative data further includes position icon data indicating a relative position of the sound source relative to the position of the vehicle.

The display is further configured to output the position icon data.

In the data processing of the surrounding environment data, the processor of the vehicle is further configured to:

estimate the relative position of the relative position based on the acoustic analysis; and

add relative position data indicating the relative position data to the data for communication.

In the control processing, the processor of the remote facility is further configured to select the position icon data corresponding to the estimated relative position by using the relative position data.

A fourth aspect further has the following features in the first aspect.

The alternative data includes pseudo sound data corresponding to the estimated type.

The reproduction device includes a headphone configured to output the pseudo sound data.

In the control processing, the processor of the remote facility is further configured to

by referring to the databased of the remote facility using the specified identification data, select the pseudo sound data corresponding to the estimated type.

A fifth aspect further has the following features in the fourth aspect.

In the data processing of the surrounding environment data, the processor of the vehicle is further configured to:

estimate the relative position of the relative position based on the acoustic analysis; and

add relative position data indicating the relative position data to the data for communication.

In the control processing, the processor of the remote facility is further configured to convert the pseudo sound data into a stereophonic signal based on the relative position data.

A sixth aspect further has the following features in the fourth aspect.

In the data processing of the surrounding environment data, the processor of the vehicle is further configured to:

estimate a distance from the vehicle to the sound source based on the acoustic analysis; and

add distance data indicating the estimated distance to the data for communication.

In the control processing, the processor of the remote facility is further configured to adjust an output level of the pseudo sound data outputted from the headphone based on the distance data.

A seventh aspect is a method for a remote assistance of an operation of a vehicle and has the following features.

A processor of the vehicle is configured to:

execute data processing of surrounding environment data of the vehicle; and

execute transmission processing to transmit data for transmission indicating the processed data by the data processing of the surrounding environment data to a remote facility configured to perform the remote assistance.

A processor of the remote facility is configured to:

execute data processing of the data for communication; and

execute control processing to play on a reproduction device of the remote facility data for reproduction indicating the processed data by the data processing.

The surrounding environment data includes sound data of the surrounding environment of the vehicle.

In the data processing of the surrounding environment data, the processor of the vehicle is configured to:

based on an acoustic analysis of the sound data, estimate a type of a source of the said sound data; and

make a reference to a database of the vehicle in which identification data corresponding to types of the environmental sound is stored based on the estimated type, specify identification data corresponding to the estimated type, and add the specified identification data to the data for communication.

The processor of the remote facility is configured to:

in the data processing of the data for communication, make a reference to a database of the remote facility in which alternative data of the environmental sound is stored is based on the specified identification data, and specify alternative data corresponding to the estimated type; and

in the control processing, output the data for reproduction including the identified alternative data to the reproduction device.

According to the first or seventh aspect, the sound data is not directly transmitted from the vehicle to the remote facility, but the identification data is transmitted instead. This identification data is data corresponding to the type of the environmental sound estimated by the acoustic analysis of the sound data. Therefore, it is possible to reduce the data traffic related to the sound data significantly as compared to a case where the sound data is transmitted.

In the remote facility, the alternative data is specified based on the identification data, and the data for reproduction including this alternative data is outputted to the reproduction device. Therefore, the operator can confirm the environmental sound. Therefore, it is also possible to secure a safety of the operation of the vehicle when the remote assistance by the operator is performed.

According to the second aspect, the sound source icon data is outputted to the display. The sound source icon data is icon data corresponding to the type of the environmental sound. Therefore, according to the sound source icon data, the operator can visually confirm the environmental sound. Therefore, it is possible to enhance the safety of the operation of the vehicle when the remote assistance is performed.

According to the third aspect, the position icon data is outputted to the display. The position icon data is icon data indicating the relative position of the sound source with respect to the position of the vehicle. Therefore, it is possible to increase the effect by the second aspect.

According to the fourth aspect, the pseudo sound data is outputted from the headphone. The pseudo sound data is sound data corresponding to the type of the environmental sound. Therefore, according to the pseudo sound data, the environmental sound can be confirmed by the operator through hearing. Therefore, it is possible to obtain an effect equivalent to the effect by the second aspect.

According to the fifth aspect, the stereophonic signal obtained by the processing of the pseudo sound data is outputted from the headphone. Therefore, it is possible to enhance the effect of the fourth aspect.

According to the sixth aspect, the output level of the pseudo sound data outputted from the headphone is adjusted based on the distance data. Therefore, it is possible to enhance the effect of the fourth aspect.

### BRIEF DESCRIPTION OF DRAWINGS

FIG. 1 is a block diagram showing a configuration example of a remote assistance system according to an embodiment of the present disclosure;

FIG. 2 is a block diagram showing a function configuration example of a data processing device of a vehicle;

FIG. 3 is a diagram showing a first configuration example of the data for communication transmitted the vehicle to a remote facility;

FIG. 4 is a diagram showing a second configuration example of the data for communication transmitted from the vehicle to the remote facility;

FIG. 5 is a diagram showing a third configuration example of the data for communication transmitted from the vehicle to the remote facility;

FIG. 6 is a block diagram showing a function configuration example of a data processing device of the remote facility;

FIG. 7 is a diagram showing a first configuration example of alternative data:

FIG. 8 is a diagram showing a second configuration example of the alternative data:

FIG. 9 is a diagram showing an example of a display content of a display when the display content is controlled by a display control part;

FIG. 10 is a flowchart showing a flow of processing of sound data executed by a data processing device of the vehicle; and

FIG. 11 is a flowchart showing a flow of data processing executed by a data processing device of the remote facility.

### DESCRIPTION OF EMBODIMENT

Hereinafter, an embodiment of a remote assistance system and a remote assistance method according to present disclosure will be described reference to the drawings. Note that the remote assistance method according to the embodiment is realized by computer processing executed in the remote assistance system according to the embodiment. In the drawings, the same or corresponding portions are denoted by the same sign, and descriptions to the portions are simplified or omitted.

### 1. Configuration Example of Remote Assistance System

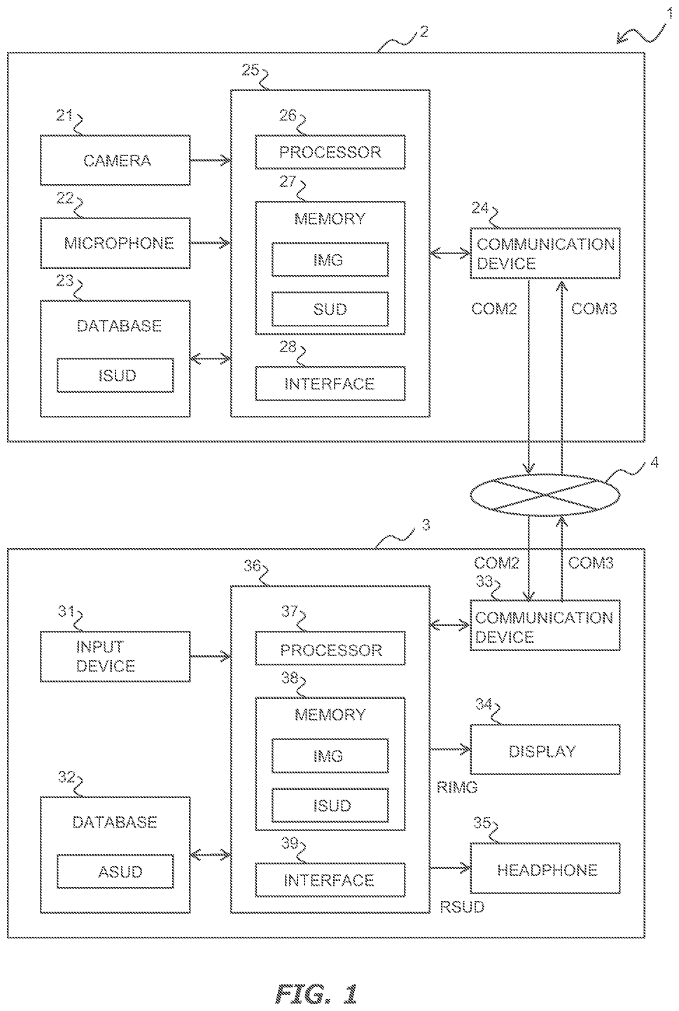

FIG. 1 is a block diagram showing a configuration example of a remote assistance system according to the embodiment. As shown in FIG. 1, a remote assistance system 1 comprises a vehicle 2 and a remote facility 3 that communicates with the vehicle 2. The communication between the vehicle 2 and the remote facility 3 is performed via a network 4.

Examples of the vehicle 2 include a vehicle in which an internal combustion engine such as a diesel engine or a gasoline engine is used as a power source, an electronic vehicle in which an electric motor is used as the power source, or a hybrid vehicle including the internal combustion engine and the electric motor. The electric motor is driven by a battery such as a secondary cell, a hydrogen cell, a metallic fuel cell, and an alcohol fuel cell.

The vehicle 2 runs by an operation of a driver of the vehicle 2. The operation of the vehicle 2 may be performed by a control system mounted on the vehicle 2. This control system, for example, supports the running of the vehicle 2 by an operation of the driver, or controls for an automated running of the vehicle 2. If the driver or the control system make a remote request to the remote facility 3, the vehicle 2 runs by the operation of an operator residing in the remote facility 3.

The vehicle 2 includes a camera 21, a microphone 22, a database 23, a communication device 24, and a data processing device 25. The camera 21, the microphone 22, the database 23 and the communication device 24, and the data processing device 25 are connected by an in-vehicle network (e.g., a CAN (Car Area Network)).

The camera 21 capture an image (a moving image) of surrounding environment of the vehicle 2. The camera 21 includes at least one camera provided for capturing the image at least in front of the vehicle 2. The camera 21 for capturing the front image is, for example, on a back of a windshield of the vehicle 2. The image data IMG acquired by the camera 21 is transmitted to the data processing device 25.

The microphone 22 acquires sound of the surrounding environment (i.e., environmental sound) of the vehicle 2. The microphone 22 provided on the vehicle 2 at least one. The at least one microphone is provided, for example, on a front bumper or roof of the vehicle 2. When measuring a relative position relative to a position of the vehicle 2 to a source of the sound (hereinafter also referred to as a “sound source”) or measuring a distance from the vehicle 2 to the sound source, it is desirable that the microphone 22 includes at least two microphones. The at least two microphones include, for example, two microphones that are provided on opposite sides of the front bumper and two microphones that are provided on opposite sides of a rear bumper of the vehicle 2. The sound data SLID acquired by the microphone 22 is transmitted to the data processing device 25.

The data base 23 is a nonvolatile storage medium such as a flash memory and a HDD (Hard Disk Drive). The data base 23 stores various program and various data required for the running of the vehicle 2. The examples of the various data include map data used for navigating the vehicle 2. The data base 23 also stores various data required for the operation of the remote assistance of the vehicle 2. Examples of this various data include identification data ISUD. The identification data ISUD is data corresponding to various sounds related to the running of the vehicle 2. The various sounds are set in advance.

Here, examples of the various sounds include a horn sound, a railroad crossing sound, an emergency vehicle sound, and a traffic light machine sound. The horn sound is the sound generated when the horn (alarm) of vehicle is activated. The railroad crossing sound is a sound generated when an alarm installed at a railroad crossing is activated. The emergency vehicle sound is a sound generated when an alarm of an emergency vehicle (e.g., a patrol car, an ambulance, and a fire engines) is activated. The traffic light machine sound is a sound emitted from a traffic light provided adjacently to a crosswalk to ensure safety of a walker or the like crossing the crosswalk.

The communication device 24 is a device for connecting to the network 4. A communication partner of the communication device 24 includes the remote facility 3. In the communication with the remote facility 3, the communication device 24 transmits to the remote facility 3 “data for communication COM2” that is received from the data processing device 25.

The data processing device 25 is a computer for processing various data acquired by the vehicle 2. The data processing device 25 includes at least a processor 26, a memory 27, and an interface 28. The memory 27 is a volatile memory, such as a DDR memory, which develops program used by the processor 26 and temporarily stores various data. The various data acquired by the vehicle 2 is stored in the memory 27. This various data includes the image data IMG and the sound data SUD described above. The interface 28 is an interface with external devices such as the camera 21 and the microphone 22.

The processor 26 encodes the image data IMG and outputs it to the communication device 24 via the interface 28. During the encoding process, the image data IMG may be compressed. The encoded image data IMG is included in the data for communication (COM2. The processor 26 also executes an acoustic analysis of the sound data SUD to identify types of sounds included in the sound data SUD. The processor 26 further specifies the identification data ISUD corresponding to the identified sound type by referring to the data base 23 using the said type. The processor 26 encodes the identification data ISUD and outputs it to the communication device 24 via the interface 28. That is, the encoded identification data ISUD is added to the data for communication COM2.

The encoding process of the image data IMG, the analysis process of the sound data SUD, the processing to specify the identification data ISUD, and the encoding process of the identification data ISUD need not be executed using the processor 26, the memory 27, and the database 23. For example, the various processes may be executed by software processing in a GPU (Graphics Processing Unit) or a DSP (Digital Signal Processor), or by hardware processing in an ASIC or a FPGA.

The remote facility 3 includes an input device 31, a data base 32, a communication device 33, a display 34, headphone 35, and a data processing device 36. The input device 31, the data base 32, the communication device 33, the display 34 and the headphone 35, and the data processing device 36 are connected by a dedicated network.

The input device 31 is a device operated by the operator who performs the remote assistance of the vehicle 2. The input device 31 includes an input unit for receiving an input from the operator, and a control circuit for generating and outputting an input signal based on the input. Examples of the input unit include a touch panel, a mouse, a keyboard, a button, and a switch. Examples of the input by the operator include a cursor movement operation displayed on the display 34 and a button selection operation displayed on the display 34.

When the operator performs a remote operation of the vehicle 2, the input device 31 may be provided with an input device for running. Examples of the input device for running include a steering wheel, a shift lever, an accelerator pedal, and a brake pedal.

The database 32 is a non-volatile storage medium such as a flash memory or a HDD. The data base 32 stores various program and various data required for the remote assistance (or the remote operation) of the vehicle 2. Examples of this various data include alternative data ASUD. The alternative data ASUD is data corresponding to various sounds related to the running of the vehicle 2. The various sounds are the same as those exemplified in the explanation of the identification data ISUD (i.e., the horn sound, the railroad crossing sound, the emergency vehicle sound, and the traffic light machine sound).

The communication device 33 is a device for connecting to the network 4. A communication partner of the communication device 33 includes the vehicle 2. In the communication with the vehicle 2, the communication device 33 transmits to the vehicle 2 “data for communication COM 3” that is received from the data processing device 36.

The display 34 and the headphone 35 are examples of a reproduction device for reproducing the surrounding environment of the vehicle 2 on the remote facility 3. Examples of the display 34 include a liquid crystal display (LCD: Liquid Crystal Display) and an organic EL (OLED: Organic Light Emitting Diode) display. The display 34 operates based on “data for reproduction RIMG” received from the data processing device 36. The headphone 35 is a device for outputting a sound signal. The headphone 35 may output stereoscopic sound signals based on stereoscopic information indicating a position of the sound source. The headphone 35 operates based on “data for reproduction RSUD” received from the data processing device 36.

The data processing device 36 is a computer for processing various data. The data processing device 36 includes at least a processor 37, a memory 38, and an interface 39. The memory 38 develops program used by the processor 37 and temporarily stores various data. The signals inputted from the input device 31 and the various data acquired by the remote facility 3 are stored in the memory 38. This various data includes the image data IMG and the identification data ISUD contained in the data for communication COM2. The interface 39 is an interface with external devices such as the input device 31, the database 32, and the like.

The processor 37 decodes the image data IMG and outputs it to the display 34 via the interface 39. If the image data IMG is compressed, the image data IMG is decomposed in decoding process. The decoded image data IMG corresponds to the data for reproduction RIMG.

The processor 37 also decodes the identification data ISUD. Then, the alternative data ASUD corresponding to the identification data ISUD is specified by referring to the data base 32 using the decoded identification data ISUD. The processor 37 then adds the alternative data ASUD to the data for reproduction RIMG or RSUD.

The decoding process of the image data IMG and the identification data ISUD, the processing to specify the alternative data ASUD, and the output process of the data for reproduction RIMG may not be executed using the processor 37, the memory 38, and the database 32. For example, the various processes may be executed by software processing in a GPU or a DSP, or by hardware processing in an ASIC or a FPGA.

### 2. Function Configuration Example of the Data Processing Device of the Vehicle

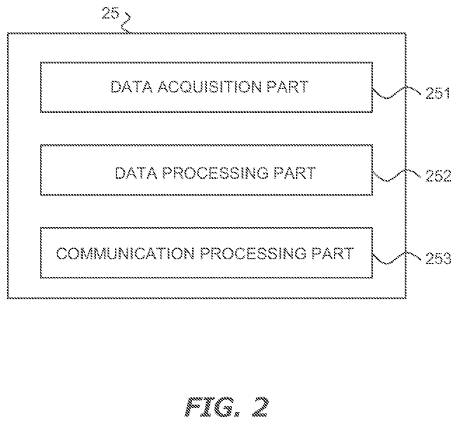

FIG. 2 is a block diagram showing a function configuration example of the data processing device 25 shown in FIG. 1. As shown in FIG. 2, the data processing device 25 includes a data acquisition part 251, a data processing part 252, and a communication processing part 253.

The data acquisition part 251 acquires the surrounding environment data of the vehicle 2, driving state data of the vehicle 2, location data of the vehicle 2 and map data. Examples of the surrounding environment data include the image data IMG and the sound data SUD described above. Examples of the driving state data include driving speed data, acceleration data, and yaw rate data of the vehicle 2. These driving state data are measured by various sensors mounted on the vehicle 2. The location data is measured by a GNSS (Global Navigation Satellite System) receiver.

The data processing part 252 processes various data acquired by the data acquisition part 251. The various data processing includes the encoding process of the image data IMG, the analysis process of the sound data SUD, the processing to specify the identification data ISUD, and the encoding process of the identification data ISUD. In the analysis process of the sound data SUD, the types of the sounds included in the sound data SUD are identified. For example, a known technique disclosed in JP2011-85824A can be applied to the identification processing. In the analysis process of the sound data SUD, a relative position of the sound source or a distance from the vehicle 2 to the sound source may be calculated. For example, a known technique disclosed in JP2017-151216A can be applied to this calculation processing.

The communication processing part 253 transmits the image data IMG and the identification data ISUD (i.e., the data for communication COM2) encoded by the data processing part 252 to the remote facility 3 (the communication device 33) via the communication device 24.

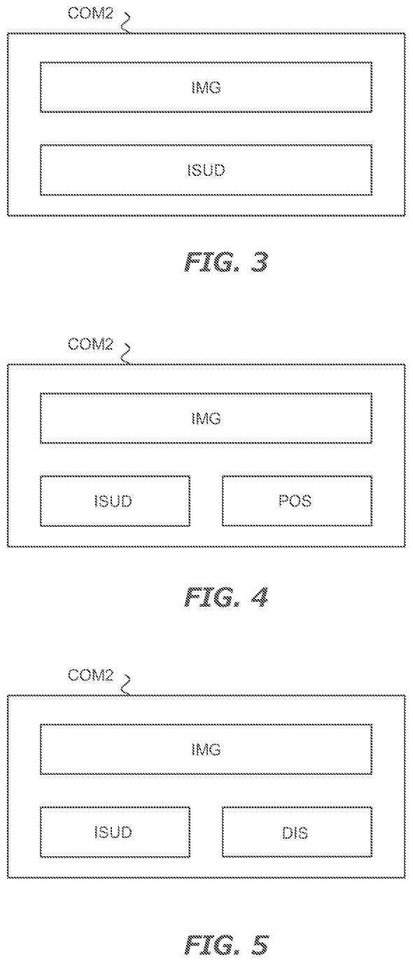

Here, a configuration example of the data for communication COM2 will be described with reference to FIGS. 3 to 5. FIG. 3 is a diagram showing a first configuration example of the data for communication COM2. In this first example, the data for communication COM2 includes the encoded image data IMG and the identification data ISUD.

FIG. 4 is a diagram showing a second configuration example of the data for communication COM2. In this second example, encoded relative position data POS is added to the data for communication COM2 described in the first example. The relative position data POS indicates data of the relative position of the sound source. If the relative position of the sound source is computed in the analysis process of the sound data SUD, the relative position data POS is generated and encoded. Thus, in this case, the data for communication COM2 includes the encoded image data IMG, the encoded identification data ISUD and the encoded relative position data POS.

FIG. 5 is a diagram showing a third configuration example of the data for communication COM2. In this third example, encoded distance data DIS is added to the data for communication COM2 described in the first example. The distance data DIS is data indicating the distance from the vehicle 2 to the sound source. If the distance from the vehicle 2 to the sound source is calculated in the analysis process of the sound data SUD, the distance data DIS is generated and encoded. Thus, in this case, the data for communication COM2 includes the encoded image data IMG, the encoded identification data ISUD and the encoded distance data DIS.

Note that second example and third example may be combined. In this instance, the data for communication COM2 includes the encoded image data IMG, the encoded identification data ISUD, the encoded relative position data POS and the encoded distance data DIS.

### 3. Function Configuration Example of the Data Processing Device of the Remote Facility

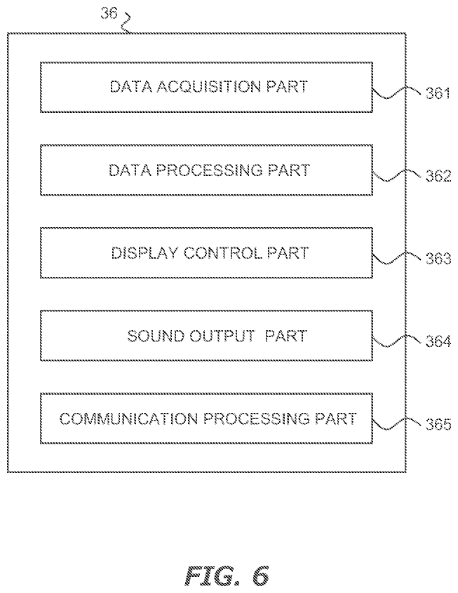

FIG. 6 is a block diagram showing function configuration example of the data processing device 36 shown in FIG. 1. As shown in FIG. 6, the data processing device 36 includes a data acquisition part 361, a data processing part 362, a display control part 363, a sound output control part 364, and a communication processing part 365.

The data acquisition part 361 acquires an input signal by the operator and the data for communication COM2 from the vehicle 2.

The data processing part 362 processes various data acquired by the data acquisition part 361. The processing of various data includes the processing to encode the input signal by the operator. The encoded input signal corresponds to a remote assistance signal (or a remote operation signal) of the operation of the vehicle 2 included in the data for communication COM3. The various data processing includes the decoding processing of the data for communication COM2 and the processing to specify the alternative data ASUD. In the processing to specify the alternative data ASUD, the alternative data ASUD corresponding to the decoded identification data ISUD by referencing the data base 32 using the said identification data ISUD.

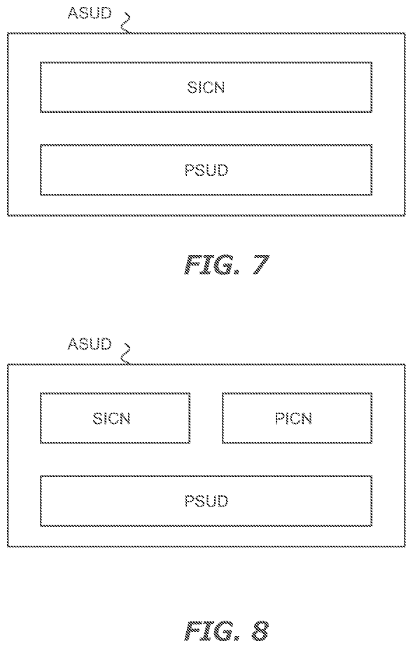

The configuration example of alternative data ASUD will be described with reference to FIGS. 7 and 8. FIG. 7 is a diagram showing a first configuration example of the alternative data ASUD. In this first example, the alternative data ASUD includes sound source icon data SICN and pseudo sound data PSUD. The sound source icon data SICN is icon data indicating the sources of the various sounds related to the running of the vehicle 2 (i.e., the horn sound, the railroad crossing sound, the emergency vehicle sound, and the traffic light machine sound). For example, if the quotation is sound source, sound source icon data SICN is icon data indicating that a surrounding vehicle has issued a horn. The pseudo sound data PSUD is data imitating various sounds related to the running of the vehicle 2. The pseudo sound data PSUD is set in advance.

FIG. 8 is a diagram showing a second configuration example of the alternative data ASUD. In this second example, position icon data PICN is added to the alternative data ASUD described in the first example. The position icon data PICN is icon data indicating the relative position of the sound source by an arrow. The position icon data PICN is specified when the decoded data for communication COM2 includes the relative position data POS (see FIG. 4).

The display control part 363 controls a display content of the display 34 provided to the operator. The control of this display content is based on the decoded image data IMG (i.e., the data for reproduction RIMG). The display control part 363 also controls the display content based on the input signal by the operator acquired by the data acquisition part 361. In the control of the display content based on the input signal, for example, the display content is enlarged or reduced based on the input signal, or a switching (a transition) of the display content is performed. In another example, a cursor displayed on the display 34 is moved or a button displayed on the display 34 is selected based on the input signal.

The display control part 363 further controls the display content based on the alternative data ASUD. In the control of the display content based on the alternative data ASUD, for example, the sound source icon data SICN described with reference to FIG. 7 is added to the data for reproduction RIMG. In the control of the display content based on the alternative data ASUD, the position icon data PICN described with reference to FIG. 8 is added to the data for reproduction RIMG together with the sound source icon data SICN.

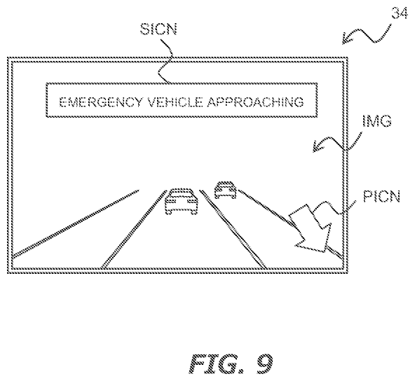

FIG. 9 is a diagram showing an example of the display content of the display 34 when the display content is controlled by the display control part 363. In the illustrative example shown in FIG. 9, the image data IMG is displayed throughout the display 34. Further, the sound source icon data SICN and the position icon data PICN are displayed superimposed on the image data IMG. The sound source icon data SICN indicates that an emergency vehicle is approaching. The position icon data PICN indicates that the relative position of the sound source (i.e., the emergency vehicle) is right rear of the vehicle 2.

The sound output control part 364 controls an output of a sound signal from the headphone 35 to the operator based on the alternative data ASUD. The control of the output is executed based on the pseudo sound data PSUD (i.e., the data for reproduction RSUD). For example, in a case of the horn is the sound source, a pseudo sound signal of the horn sound is outputted from the headphone 35.

If the decoded data for communication COM2 includes the relative position data POS (see FIG. 4), the sound output control part 364 may generate stereotactic data based on the relative position data POS. In this case, the sound output control part 364 may process the pseudo sound signal according to the stereotactic data and convert it into a stereotactic signal. In this case, a stereo sound signal is outputted from the headphones 35 as the data for reproduction RSUD.

If the decoded data for communication COM2 includes the distance data DIS (see FIG. 5), the sound output control part 364 may adjust an output level of the pseudo sound signal based on the distance data DIS. In this case, the sound output control part 364 may adjust the output level such that the closer the distance from the vehicle 2 to the sound source, the louder the volume.

The communication processing part 365 transmits to the vehicle 2 (the communication device 24) via the communication device 33 an input signal by the operator (i.e., the data for communication COM3) that is encoded by the data processing part 362.

### 4. Data Processing Example by the Data Processing Device (Processor) of the Vehicle

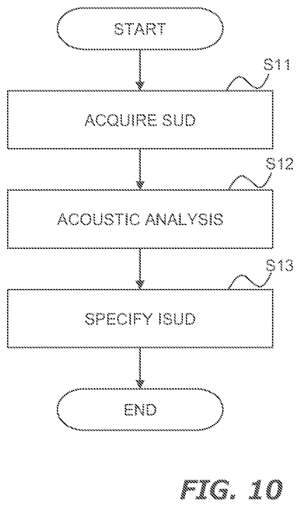

FIG. 10 is a flowchart showing a flow of processing of the sound data SUD executed by the data processing device 25 (the processor 26) shown in FIG. 1. The routine shown in FIG. 10 is repeatedly executed at a predetermined control cycle.

In the routine shown in FIG. 10, first, the sound data SUD is acquired (step S11). As described above, the sound data SUD is included in the surrounding environment data.

After the processing in the step S11, the acoustic analysis is performed (step S12). In this acoustic analysis, for example, a feature amount relating to a temporal variation of a frequency component included in the sound data SUD that was acquired in the processing in the step S11 is extracted. The extraction of the feature amount is performed by dividing the sound data SUD at regular time intervals as one block unit. Then a statistical technique such as a neural network and a Gaussian mixture model is then applied to the extracted feature amount. Thus, the type of the sound corresponding to the extracted feature amount is identified.

In the acoustic analysis, the relative position of the sound source may be calculated. In this case, the identified sound data SUD is then subjected to a method based on a phase detection, a method based on a cross-correlation coefficient, or a method based on an eigenvalue analysis of correlation matrices. For example, in the method based on the phase detection, a direction from which the sound comes at a frequency is estimated based on a phase difference between components of the said frequency of sounds detected by at least two microphones of the microphone 22, respectively. The relative position of the sound source is estimated by the estimated direction of arrival of the sound.

In the acoustic analysis, the distance from the vehicle 2 to the sound source may be calculated. For example, in method based on the phase detection, the direction of the arrival of the sound is estimated for respective microphones of the microphone 22. Therefore, by drawing an extension line from respective center positions of these microphone in a reference frame toward the estimated direction of the arrival, a coordinate of an intersection point of these extension lines is calculated. The distance from the vehicle 2 to the sound source is calculated as a length from the coordinate of this intersection to the position coordinate of the vehicle 2.

Ater the processing of the step S12, the identification data ISUD is specified (step S13). The determination of the identification data ISUD is performed by referring to the data base 23 using the type of the sound identified in the processing of the step S12. Then, the specified identification data ISUD is encoded and outputted to the interface 28.

### 5. Data Processing Example by the Data Processing Device (the Processor) of the Remote Facility

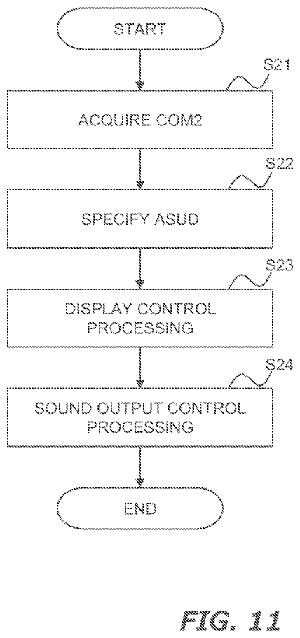

FIG. 11 is a flowchart showing a flow of data process executed by the data processing device 36 (the processor 37) shown in FIG. 1. The routine shown in FIG. 11 is repeatedly executed at a predetermined control cycle when, for example, the processor 37 receives a signal of the remote request to the remote facility 3. The signal of the remote request is included in the data for communication COM2.

In the routine shown in FIG. 11, first, the data for communication COM2 is acquired (step S21). The data for communication COM2 acquired in the processing in the step S21 includes the encoded image data IMG and the encoded identification data ISUD. At least one of the encoded relative position data POS and the encoded distance data DIS may be included in the data for communication COM2.

After the processing in the step S21, the alternative data ASUD is specified (step S22). In the determination of the alternative data ASUD, first, the data for communication COM2 (i.e., the identification data ISUD acquired in the step S21) is decoded. Then, by referring to the database 32 using this identification data ISUD, the alternative data ASUD corresponding to the identification data ISUD is specified.

After the processing in the step S22, display control processing is executed (step S23). In the display control processing, the data for reproduction RIMG is generated based on the data for communication COM2 (i.e., the image data IMG) that was decoded in the processing of the step S21. In the display control processing, also, the alternative data ASUD (e.g., the sound source icon data SICN that was specified in the processing of the step S22) is added to the data for reproduction RIMG. Then, the data for reproduction RIMG to which the sound source icon data SICN is added is outputted to the interface 39.

When the decoded data for communication COM2 includes the relative position data POS, the alternative data ASUD corresponding to relative position data POS (i.e., the position icon data PICN) is specified. In this case, therefore, the position icon data PICN is added to the data for reproduction RIMG.

After the processing of the step S23, sound output control processing is executed (step S24). In the sound output control processing, the data for reproduction RSUD is generated based on the alternative data ASUD (i.e., the pseudo sound data PSUD) specified in the processing of the step S22. The data for reproduction RSUD is outputted to the interface 39.

If the decoded data for communication COM2 includes the relative position data POS, the stereotactic data is generated based on the relative position data POS. Then, the data for reproduction RSUD is generated based on the stereotactic data. If the decoded data for communication COM2 includes the distance data DIS, the output level of the data for reproduction RSUD is set based on the distance data DIS.

### 6. Effect

According to the embodiment described above, the sound data SUD is not transmitted directly from the vehicle 2 to the remote facility 3, but the identification data ISUD is transmitted. This identification data ISUD is data corresponding to the type of the sound identified by the analysis of the sound data SU D. Therefore, the data traffic related to sound data SUD can be reduced significantly as compared to when the sound data SUD is transmitted.

In addition, the remote facility 3 also identifies the alternative data ASUD based on the identification data ISUD and adds this alternative data ASUD (i.e., the sound source icon data SICN) to the data for reproduction RIMG. Therefore, the environmental sound can be confirmed through a vision of the operator. In addition, the alternative data ASUD (i.e., the pseudo sound data PSUD specified based on the identification data ISUD) is generated as the data for reproduction RSUD. Therefore, the environmental sound can be confirmed through an auditory sense of the operator. Therefore, it is possible to secure a safety of the running of the vehicle 2 when the remote assistance (or the remote operation) by the operator is performed.

What is claimed is:

1. A remote assistance system, comprising:
a vehicle; and
a remote facility configured to assist the operation of the vehicle,
wherein the vehicle includes:
a memory in which surrounding environment data of the vehicle is stored;
a processor configured to execute data processing of the surrounding environment data, and transmission processing to transmit data for communication indicating the processed data by the data processing to a remote facility; and
a database in which execute data processing of the surrounding environment data, and transmission processing to transmit data for communication indicating the processed data by the data processing to a remote facility,
wherein the remote facility includes:
a memory in which the data for communication is stored; and
a processor configured to execute data processing of the data for communication, and control processing to play on a reproduction device of the remote facility data for reproduction indicating the processed data by the data processing,
wherein the surrounding environment data includes sound data of the surrounding environment of the vehicle,
wherein, in the data processing of the surrounding environment data, the processor of the vehicle is configured to:
based on an acoustic analysis of the sound data, estimate a type of the sound source included in the said sound data; and
by referring to the database of the vehicle using the estimated type, specify identification data corresponding to the said estimated type and add it to the data for communication,
wherein the processor of the remote facility is configured to:
in the data processing of the data for communication, by referring to the database of the remote facility using the specified identification data, identify alternative data corresponding to the estimated type; and
in the control processing, output the data for reproduction including the identified alternative data to the reproduction device.

2. The remote assistance system according to claim 1,
wherein the alternative data includes sound source icon data corresponding to the estimated type,
wherein the reproduction device includes a display configured to output the sound source icon data,
wherein, in the data processing of the data for communication, the processor of the remote facility is further configured to select the sound source icon data corresponding to the estimated type by referring to the database of the remote facility using the specified identification data.

3. The remote assistance system according to claim 2,
wherein the alternative data further includes position icon data indicating a relative position of the sound source relative to the position of the vehicle,
wherein the display is further configured to output the position icon data,
wherein, in the data processing of the surrounding environment data, the processor of the vehicle is further configured to:
estimate the relative position of the relative position based on the acoustic analysis; and
add relative position data indicating the relative position data to the data for communication,
wherein, in the control processing, the processor of the remote facility is further configured to select the position icon data corresponding to the estimated relative position by using the relative position data.

4. The remote assistance system according to claim 1,
wherein the alternative data includes pseudo sound data corresponding to the estimated type,
wherein the reproduction device includes a headphone configured to output the pseudo sound data,
wherein, in the control processing, the processor of the remote facility is further configured to select the pseudo sound data corresponding to the estimated type by referring to the databased of the remote facility using the specified identification data.

5. The remote assistance system according to claim 4,
wherein, in the data processing of the surrounding environment data, the processor of the vehicle is further configured to:
estimate the relative position of the relative position based on the acoustic analysis; and
add relative position data indicating the relative position data to the data for communication,
wherein, in the control processing, the processor of the remote facility is further configured to convert the pseudo sound data into a stereophonic signal based on the relative position data.

6. The remote assistance system according to claim 4,
wherein, in the data processing of the surrounding environment data, the processor of the vehicle is further configured to:
estimate a distance from the vehicle to the sound source based on the acoustic analysis; and
add distance data indicating the estimated distance to the data for communication,
wherein, in the control processing, the processor of the remote facility is further configured to adjust an output level of the pseudo sound data outputted from the headphone based on the distance data.

7. A method for a remote assistance of an operation of a vehicle,
wherein a processor of the vehicle is configured to:
execute data processing of surrounding environment data of the vehicle; and
execute transmission processing to transmit data for transmission indicating the processed data by the data processing of the surrounding environment data to a remote facility configured to perform the remote assistance,
wherein a processor of the remote facility is configured to:
execute data processing of the data for communication; and
execute control processing to play on a reproduction device of the remote facility data for reproduction indicating the processed data by the data processing,
wherein the surrounding environment data includes sound data of the surrounding environment of the vehicle,
wherein, in the data processing of the surrounding environment data, the processor of the vehicle is configured to:
based on an acoustic analysis of the sound data, estimate a type of a source of the said sound data; and
make a reference to a database of the vehicle in which identification data corresponding to types of the environmental sound is stored based on the estimated type, specify identification data corresponding to the estimated type, and add the specified identification data to the data for communication,
wherein, the processor of the remote facility is configured to:
in the data processing of the data for communication, make a reference to a database of the remote facility in which alternative data of the environmental sound is stored is based on the specified identification data, and specify alternative data corresponding to the estimated type; and
in the control processing, output the data for reproduction including the identified alternative data to the reproduction device.
